(19) United States
(12) Patent Application Publication
(10) Pub. No.: US 2023/0332268 A1
(43) Pub. Date: Oct. 19, 2023

(54) METHOD FOR RECOVERING AND PURIFYING NICKEL FROM FERRONICKEL

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Haijun Yu, Foshan (CN); Yingsheng Zhong, Foshan (CN); Yinghao Xie, Foshan (CN); Aixia Li, Foshan (CN); Xuemei Zhang, Foshan (CN); Changdong Li, Foshan (CN)

(21) Appl. No.: 18/211,589

(22) Filed: Jun. 19, 2023

Related U.S. Application Data
(63) Continuation of application No. PCT/CN2022/095673, filed on May 27, 2022.

(30) Foreign Application Priority Data
Aug. 13, 2021 (CN) 202110929403.4

(51) Int. Cl. C22B 7/00; C22B 3/00; C01G 53/09

(52) U.S. Cl. CPC C22B 23/0423; C01G 53/09; C22B 7/007; C22B 23/0461

(57) ABSTRACT

The present disclosure discloses a method for recovering and purifying nickel from ferronickel, comprising the following steps: (1) mixing ferronickel with hydrochloric acid, and heating for dissolution; subjecting a resulting slurry to solid-liquid separation to obtain a liquid phase; and adding an oxidant to the liquid phase to obtain a hydrochloric acid-leaching liquor; (2) subjecting the hydrochloric acid-leaching liquor to evaporation, and adding a precipitating agent to allow a reaction; separating out a liquid phase, adding ammonia water to adjust a pH, and adding a water-soluable alcohol solution; and cooling for precipitation to obtain a nickel complex crystal; and (3) dissolving the nickel complex crystal, and adding an oxidant; and subjecting a resulting mixture to a light treatment, and adjusting a pH with an acid to obtain a nickel chloride solution.

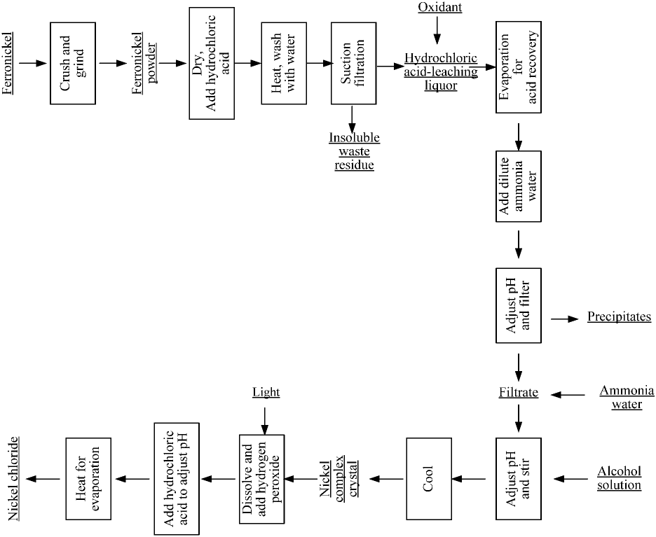

### CROSS-REFERENCE TO RELATED APPLICATIONS

The present application is a continuation application of PCT application No. PCT/CN2022/095673 filed on May 27, 2022, which claims the benefit of Chinese Patent Application No. 202110929403.4 filed on Aug. 13, 2021. The contents of all of the aforementioned applications are incorporated by reference herein in their entirety.

### TECHNICAL FIELD

The present disclosure belongs to the technical field of ferronickel recycling, and specifically relates to a method for recovering and purifying nickel from ferronickel.

### BACKGROUND

According to different mineral compositions of nickel laterite ore, a nickel laterite ore deposit is divided into 3 ore layers: a limonite ore layer, a saprolitic ore layer, and a transitional ore layer. The nickel laterite ore in the limonite ore layer is a low-nickel nickel laterite ore, and ferronickel smelted from the low-nickel nickel laterite ore has a low nickel content, but has high contents of other metals such as silicon, iron, magnesium, and aluminum, where the chemical element contents vary greatly and a mineral composition is complex and changeable. Therefore, a nickel sulfate primary liquid obtained after subjecting the ferronickel to acid leaching and purification has a low nickel content and high contents of iron, cobalt, magnesium, and other impurities. In order to ensure the quality of a nickel sulfate product, nickel matte needs to be subjected to smelting and nickel enrichment multiple times to obtain high-nickel nickel matte. Iron, cobalt, magnesium, calcium, aluminum, and other impurities in nickel sulfate obtained by acid leaching need to be removed in steps, which results in many impurity removal steps and a complicated process, consumes lots of reagents, and introduces impurities into nickel. Therefore, there is an urgent need for a process that can recover various impurities at a time and purify nickel with reduced impurity removal steps and low energy consumption.

### SUMMARY

The present disclosure is intended to solve at least one of the technical problems existing in the prior art. In view of this, the present disclosure provides a method for recovering and purifying nickel from ferronickel. In the method, ferronickel is subjected to acid leaching under an atmospheric pressure, then metal ions affecting a complexation reaction are separated out through synchronous precipitation, then nickel is selectively complexed, and a large amount of nickel complex crystal is obtained using a water-soluable alcohol solution (because the nickel complex has very low solubility in the water-soluable alcohol solution), which improves a recovery rate of nickel.

To achieve the above objective, the present disclosure adopts the following technical solutions:

A method for recovering and purifying nickel from ferronickel is provided, including the following steps:
(1) mixing ferronickel with hydrochloric acid, and heating for dissolution; subjecting a resulting slurry to solid-liquid separation (SLS) to obtain a liquid phase; and adding an oxidant to the liquid phase to obtain a hydrochloric acid-leaching liquor;
(2) subjecting the hydrochloric acid-leaching liquor to evaporation, and adding a precipitating agent to allow a reaction; separating out a liquid phase, adding ammonia water to adjust a pH, and adding a water-soluable alcohol solution; and cooling for precipitation to obtain a nickel complex crystal; and
(3) dissolving the nickel complex crystal, and adding an oxidant; and subjecting a resulting mixture to a light treatment, and adjusting a pH with an acid to obtain a nickel chloride solution.

Preferably, before the mixing ferronickel with hydrochloric acid, step (1) further includes crushing and drying the ferronickel; and the drying is conducted at 100° C. to 150° C. for 1 h to 2 h.

Preferably, in step (1), a liquid-to-solid ratio of the hydrochloric acid to the ferronickel is 100:(400-800) ml/g.

Preferably, in step (1), hydrogen chloride has a concentration of > 5 mol/L in the hydrochloric acid.

Preferably, in step (1), the heating for dissolution may be conducted at 200° C. to 350° C. for 30 min to 60 min.

Preferably, before the SLS, step (1) further includes washing the slurry obtained after the heating for dissolution 1 to 2 times with water of 50° C. to 95° C.

Preferably, a volume ratio of the ferronickel slurry to the hot water during the water-washing process is 10:(30-60).

Preferably, in step (1), the oxidantis one from the group consisting of hydrogen peroxide and chlorine.

The precipitation of high-valent iron requires a low pH. The precipitation pH of divalent iron and the precipitation pH of nickelare overlapped, both of which arehigh pH. Therefore, the oxidant is added for oxidization of divalent iron to prevent a co-precipitation of iron and nickel.

Preferably, in step (2), the evaporation is conducted at 70° C. to 90° C. until the hydrochloric acid-leaching liquor is reduced by 200 ml/L to 400 ml/L.

Preferably, in step (2), the precipitating agent is ammonia water.

Further preferably, ammonia in the ammonia water has a mass concentration of 0.01% to 0.5%.

A precipitating agent is added to the hydrochloric acid-leaching liquor and a pH of the hydrochloric acid-leaching liquor is adjusted to generate a precipitate through hydrolysis precipitation, and the precipitate is filtered out and recovered. When the pH of the hydrochloric acid-leaching liquor is 1.2 to 2.8, iron hydroxide is recovered; when the pH is 3.0 to 4.8, aluminum hydroxide is recovered; and when the pH is 5.0 to 5.5, chromium hydroxide is recovered.

Preferably, in step (2), the reaction is conducted at 40° C. to 80° C.

Preferably, in step (2), ammonia in the ammonia water has a mass concentration of 1% to 10%.

Preferably, in step (2), the ammonia water is added to adjust the pH of the liquid phase to 7.8 to 8.8.

Preferably, in step (2), the water-soluable alcohol solution is at least one selected from the group consisting of methanol, ethanol, n-propanol, and i-propanol.

Preferably, in step (2), the cooling for precipitation is achieved by cooling to 30° C. to 40° C.

Preferably, in step (2), the nickel complex crystal is at least one selected from the group consisting of Ni(NH₃)₂Cl₂, Ni(NH₃)₃Cl₂, Ni(NH₃)₄Cl₂, Ni(NH₃)₅Cl₂, and Ni(NH₃)₆Cl₂.

Preferably, in step (3), the dissolving is conducted at 40° C. to 70° C.

Preferably, in step (3), a solid-to-liquid ratio of the nickel complex crystal to the water for the dissolutionis 1 to 20 g/ml.

Preferably, in step (3), the oxidant is one from the group consisting of hydrogen peroxide and chlorine.

Preferably, in step (3), the light treatment is conducted for 30 min to 90 min.

Further preferably, the light treatment is conducted at a light wavelength of <450 nm.

Preferably, in step (3), the acid is hydrochloric acid.

Further preferably, the acid has a concentration of 0.01 mol/L to 0.40 mol/L.

Preferably, in step (3), the pHis adjusted to 6 to 6.5.

The addition of the acid to reduce the pH is conducted to prevent the precipitation of nickel chloride.

Preferably, step (3) further includes subjecting the nickel chloride solution to evaporation to obtain a nickel chloride crystal.

Compared with the prior art, the present disclosure has the following beneficial effects.

1. In the present disclosure, a ferronickel powder is subjected to acid leaching under an atmospheric pressure, an oxidant is added to oxidize low-valent iron and low-valent cobalt into high-valent iron and high-valent cobalt (which facilitates the separation of iron, cobalt, and other metal ions affecting the subsequent complexation reaction through synchronous precipitation), and then nickel is selectively complexed, such that only a nickel complex exists in a solution (alkali metals Mg and Ca will not be complexed); and then a water-soluable alcohol solution is added to the nickel complex to precipitate out a large amount of a nickel complex crystal such as Ni(NH₃)₂Cl₂, Ni(NH₃)₃Cl₂, Ni(NH₃)₄Cl₂, Ni(NH₃)₅Cl₂, or Ni(NH₃)₆Cl₂. A distance between a water molecule and hydroxyl of the alcohol decreases to form a hydrogen bond, and under the action of the hydrogen bond, more and more water molecules are miscible with the alcohol, and a water content in the nickel complex is reduced, thereby reducing the solubility of the nickel complex.

2. The present disclosure strengthens the decomplexation and reduces the dosage and types of impurity removal agents. Ni(NH₃)₄Cl₂, Ni(NH₃)₂Cl₂, and other complexes are subjected to light treatment in a strong oxidizing aqueous solution. The radiation generated by light can strengthen the decomplexation to generate more free radicals, which can quickly degrade Ni(NH₃)₄Cl₂ and Ni(NH₃)₂Cl₂ to produce NiCl₂. In the present disclosure, only ammonia water is used for impurity removal, and no other agents are used, which can avoid the introduction of new impurities.

3. The present disclosure adopts the synchronous precipitation to separate out different metal ions, which can be recycled. After the oxidation treatment, during the process of adding dilute ammonia water, when a pH of the hydrochloric acid-leaching liquor is 1.2 to 2.8, iron hydroxide is obtained; when the pH is 3.0 to 4.8, aluminum hydroxide is obtained; and when the pH is 5.0 to 5.5, chromium hydroxide is obtained. The precipitates can be recycled.

### BRIEF DESCRIPTION OF THE DRAWINGS

The sole the FIGURE is a process flow diagram of Example 1 of the present disclosure.

### DETAILED DESCRIPTION

The concepts and technical effects of the present disclosure are clearly and completely described below in conjunction with examples, so as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Example 1

A method for recovering and purifying nickel from ferronickel was provided in this example, including the following steps:
(1) Ferronickel was crushed into ferronickel scraps with a measured nickel content of 31.7%, and then the ferronickel scraps were ground and sieved to obtain 4.60 kg of a ferronickel powder; the ferronickel powder was placed in a closed container, then dried at 115° C. in a furnace for 1.2 h, and then transferred into a container; 23 L of hydrochloric acid with a concentration of 9.5 mol/L was added, and a resulting mixture was thoroughly mixed, heated to 230° C. to allow a reaction for 50 min, and then cooled to room temperature; a resulting ferronickel slurry was washed 2 times with hot water of 69° C. and then subjected to SLS to remove insoluble waste residue; and 1.5 L of hydrogen peroxide with a mass fraction of 15.3% was added to obtain 41.8 L of a hydrochloric acid-leaching liquor.
2) The 41.8 L of a hydrochloric acid-leaching liquor was subjected to evaporation at 87° C. to 35.5 L, and a residue was cooled to a constant temperature; and dilute ammonia water with a mass fraction of 0.17% was added to adjust a pH to 2.53, 4.38, and 5.44 separately to recover precipitates, where resulting mixtures were filtered separately to obtain a final filtrate.
(3) Ammonia water with a mass fraction of 2.54% was added to the final filtrate, a pH of the filtrate was adjusted to 8.34, and a resulting mixture was stirred to allow a reaction at 76° C.; 9.1 L of an ethanol solution was added, and a resulting mixture was cooled to 35° C. to obtain a nickel complex crystal; and the nickel complex crystal was separated out and dried to obtain 6.97 kg of the crystal.
(4) The nickel complex crystal was dissolved with 55.7 L of water, and a resulting solution was transferred to an open container; 3.8 L of hydrogen peroxide with a mass fraction of 15.3% was added, a resulting mixture was stirred, and light of < 450 nm and 800 W was applied above the open container to conduct a light treatment for 60 min; and then 0.063 mol/L dilute hydrochloric acid was added to adjust a pH to 6.27 to obtain a nickel chloride solution, and the nickel chloride solution was subjected to evaporation at 125° C. to obtain 3.17 kg of nickel chloride.

The sole the FIGURE is a flow chart of Example 1, where ferronickel is crushed and ground into a ferronickel powder, and the ferronickel powder is dried and dissolved in hydrochloric acid; a resulting mixture is heated and then cooled, and a resulting ferronickel slurry is washed with hot water and then subjected to suction filtration to remove insoluble waste residue; an oxidant is added to a resulting filtrate to obtain a hydrochloric acid-leaching liquor; the hydrochloric acid-leaching liquor is subjected to evaporation to remove hydrogen chloride and part of the water, and then dilute ammonia water is added to adjust a pH of the hydrochloric acid-leaching liquor to generate different precipitates, where resulting mixtures are filtered separately to recover the precipitates; ammonia water is added to a final filtrate to adjust a pH, a water-soluable alcohol solution is added, and a resulting mixture is cooled to generate a nickel complex crystal; the nickel complex crystal is dissolved, an oxidant is added, and a resulting mixture is subjected to a light treatment; and then a pH is adjusted with hydrochloric acid to obtain a nickel chloride solution, and the nickel chloride solution is subjected to evaporation to obtain nickel chloride.

### Example 2

A method for recovering and purifying nickel from ferronickel was provided in this example, including the following steps:
(1) Ferronickel was crushed into ferronickel scraps with a measured nickel content of 31.7%, and then the ferronickel scraps were ground and sieved to obtain 3.57 kg of a ferronickel powder; the ferronickel powder was placed in a closed container, then dried at 115° C. in a furnace for 1.2 h, and then transferred into a container; 21 L of 9.5 mol/L hydrochloric acid was added, and a resulting mixture was thoroughly mixed, heated to 220° C. to allow a reaction for 55 min, and then cooled to room temperature; a resulting ferronickel slurry was washed 2 times with hot water of 65° C. and then subjected to suction filtration to remove insoluble waste residue; and 1.3 L of hydrogen peroxide with a mass fraction of 15.3% was added to obtain 36.9 L of a hydrochloric acid-leaching liquor.
(2) The 36.9 L of a hydrochloric acid-leaching liquor was subjected to evaporation at 85° C. to 28.2 L, and a residue was cooled to a constant temperature; and dilute ammonia water with a mass fraction of 0.17% was added to adjust a pH to 2.74, 4.66, and 5.35 separately to recover precipitates, where resulting mixtures were filtered separately to obtain a final filtrate.
(3) Ammonia water with a mass fraction of 2.54% was added to the final filtrate, a pH of the filtrate was adjusted to 8.53, and a resulting mixture was stirred to allow a reaction at 75° C.; 8.5 L of an ethanol solution was added, and a resulting mixture was cooled to 33° C. to obtain a nickel complex crystal; and the nickel complex crystal was separated out and dried to obtain 5.53 kg of the crystal.
(4) The nickel complex crystal was dissolved with 47.0 L of water, and a resulting solution was transferred to an open container; 3.2 L of hydrogen peroxide with a mass fraction of 15.3% was added, a resulting mixture was stirred, and light of < 450 nm and 800 W was applied above the open container to conduct a light treatment for 60 min; and then 0.063 mol/L dilute hydrochloric acid was added to adjust a pH to 6.21 to obtain a nickel chloride solution, and the nickel chloride solution was subjected to evaporation at 125° C. to obtain 2.44 kg of nickel chloride.

### Example 3

A method for recovering and purifying nickel from ferronickel was provided in this example, including the following steps:
(1) Ferronickel was crushed into ferronickel scraps with a measured nickel content of 31.7%, and then the ferronickel scraps were ground and sieved to obtain 2.32 kg of a ferronickel powder; the ferronickel powder was placed in a closed container, then dried at 115° C. in a furnace for 1.2 h, and then transferred into a container; 16 L of 9.5 mol/L hydrochloric acid was added, and a resulting mixture was thoroughly mixed, heated to 208° C. to allow a reaction for 64 min, and then cooled to room temperature; a resulting ferronickel slurry was washed 2 times with hot water of 61° C. and then subjected to suction filtration to remove insoluble waste residue; and 0.85 L of hydrogen peroxide with a mass fraction of 15.3% was added to obtain 32.7 L of a hydrochloric acid-leaching liquor.
(2) The 32.7 L of a hydrochloric acid-leaching liquor was subjected to evaporation at 90° C. to 24.5 L, and a residue was cooled to a constant temperature; and dilute ammonia water with a mass fraction of 0.17% was added to adjust a pH to 2.41, 4.58, and 5.37 separately to recover precipitates, where resulting mixtures were filtered separately to obtain a final filtrate.
(3) Ammonia water with a mass fraction of 2.54% was added to the final filtrate, a pH of the filtrate was adjusted to 8.51, and a resulting mixture was stirred to allow a reaction at 75° C.; 7.4 L of an ethanol solution was added, and a resulting mixture was cooled to 30° C. to obtain a nickel complex crystal; and the nickel complex crystal was separated out and dried to obtain 4.12 kg of the crystal.
(4) The nickel complex crystal was dissolved with 33.0 L of water, and a resulting solution was transferred to an open container; 2.6 L of hydrogen peroxide with a mass fraction of 15.3% was added, a resulting mixture was stirred, and light of < 450 nm and 800 W was applied above the open container to conduct a light treatment for 60 min; and then 0.063 mol/L dilute hydrochloric acid was added to adjust a pH to 6.07 to obtain a nickel chloride solution, and the nickel chloride solution was subjected to evaporation at 125° C. to obtain 1.58 kg of nickel chloride.

### Example 4

A method for recovering and purifying nickel from ferronickel was provided in this example, including the following steps:
(1) Ferronickel was crushed into ferronickel scraps with a measured nickel content of 31.7%, and then the ferronickel scraps were ground and sieved to obtain 3.45 kg of a ferronickel powder; the ferronickel powder was placed in a closed container, then dried at 115° C. in a furnace for 1.2 h, and then transferred into a container; 21.5 L of 9.5 mol/L hydrochloric acid was added, and a resulting mixture was thoroughly mixed, heated to 230° C. to allow a reaction for 60 min, and then cooled to room temperature; a resulting ferronickel slurry was washed 2 times with hot water of 65° C. and then subjected to suction filtration to remove insoluble waste residue; and 1.2 L of hydrogen peroxide with a mass fraction of 15.3% was added to obtain 31.1 L of a hydrochloric acid-leaching liquor.
(2) The 31.1 L of a hydrochloric acid-leaching liquor was subjected to evaporation at 90° C. to 26.4 L, and a residue was cooled to a constant temperature; and dilute ammonia water with a mass fraction of 0.17% was added to adjust a pH to 2.73, 4.50, and 5.49 separately to recover precipitates, where resulting mixtures were filtered separately to obtain a final filtrate.
(3) Ammonia water with a mass fraction of 2.54% was added to the final filtrate, a pH of the filtrate was adjusted to 8.74, and a resulting mixture was stirred to allow a reaction at 75° C.; 8.3 L of an ethanol solution was added, and a resulting mixture was cooled to 38° C. to obtain a nickel complex crystal; and the nickel complex crystal was separated out and dried to obtain 5.44 kg of the crystal.
(4) The nickel complex crystal was dissolved with 32.6 L of water, and a resulting solution was transferred to an open container; 3.0 L of hydrogen peroxide with a mass fraction of 15.3% was added, a resulting mixture was stirred, and light of < 450 nm and 800 W was applied above the open container to conduct a light treatment for 60 min; and then 0.063 mol/L dilute hydrochloric acid was added to adjust a pH to 6.35 to obtain a nickel chloride solution, and the nickel chloride solution was subjected to evaporation at 125° C. to obtain 2.29 kg of nickel chloride.

TABLE 1

Nickel recovery rates of Examples 1 to 4

| | Mass of ferronickel (kg) | Total mass of nickel in ferronickel (kg) | Mass of nickel chloride after evaporation (kg) | Mass of nickel in nickel chloride after evaporation (kg) | Purity of nickel chloride after evaporation (%) | Nickel recovery rate (%) |
|---|---|---|---|---|---|---|
| Example 1 | 4.60 | 1.46 | 3.17 | 1.41 | 98.2% | 96.7% |
| Example 2 | 3.57 | 1.13 | 2.44 | 1.08 | 97.6% | 95.4% |
| Example 3 | 2.32 | 0.74 | 1.58 | 0.70 | 97.9% | 95.2% |
| Example 4 | 3.45 | 1.09 | 2.29 | 1.03 | 99.3% | 94.2% |

0.200 g of ferronickel and 0.200 g of nickel chloride were weighed and dissolved in an acid separately, resulting ferronickel and nickel chloride solutions each were diluted by 2,000 times, and an inductively coupled plasma-optical emission spectrometer (ICP-OES) (ICAP-7200, Thermo Fisher Scientific) was used to determine nickel concentrations in the ferronickel and nickel chloride solutions. The indexes in Table 1 were calculated according to the following calculation formulas:
total mass of nickel in ferronickel (kg) = nickel concentration in 0.200 g ferronickel sample determined by ICAP × dilution factor × total mass (g) of ferronickel × 5/1000;
mass of nickel in nickel chloride after evaporation (kg) = nickel concentration in 0.200 g nickel chloride sample determined by ICAP × dilution factor × total mass (g) of nickel chloride × 5/1000;
purity of nickel chloride after evaporation (%) = (molar concentration of nickel in nickel chloride after evaporation × 129.6/mass of nickel chloride after evaporation) × 100%; and
nickel recovery rate (%) = mass of nickel in nickel chloride after evaporation/total mass of nickel in ferronickel × 100%.

The nickel complex crystals of Examples 1 to 4 were oxidized for decomplexation. For the mass of nickel in nickel chloride after evaporation, products of Examples 1 to 4 had 1.41 kg, 1.08 kg, 0.70 kg, and 1.03 kg, respectively; according to the calculation formula for the purity of nickel chloride after evaporation (%), the nickel chloride products prepared in Examples 1 to 4 had purities of 98.2%, 97.6%, 97.9%, and 99.3%, respectively, which were all > 97% and reached the industrial nickel standard; and the nickel recovery rates in Examples 1 to 4 were 96.7%, 95.4%, 95.2%, and 94.2%, respectively, which were all > 94%.

The examples of present disclosure are described in detail with reference to the accompanying drawings, but the present disclosure is not limited to the above examples. Within the scope of knowledge possessed by those of ordinary skill in the technical field, various changes can also be made without departing from the purpose of the present disclosure. In addition, the examples in the present disclosure or features in the examples may be combined with each other in a nonconflicting situation.

1. A method for recovering and purifying nickel from ferronickel, comprising the following steps:
(1) mixing ferronickel with hydrochloric acid, and dissolving under heating to obtain a slurry; subjecting the slurry to solid-liquid separation to obtain a liquid phase; and adding an oxidant to the liquid phase to obtain a hydrochloric acid-leaching liquor;
(2) evaporating the hydrochloric acid-leaching liquor, and adding a precipitating agent to allow a reaction; separating to obtain a liquid phase, adding ammonia water to adjust the pH, and adding a water-soluable alcohol solution; cooling for precipitation to obtain a nickel complex crystal; and
(3) dissolving the nickel complex crystal, and adding an oxidant; subjecting a resulting mixture to a light treatment, and adjusting the pH with an acid to obtain a nickel chloride solution;
wherein in step (2), the precipitating agent is an ammonia water having an ammonia mass concentration of 0.01% to 0.5%;
the reaction is conducted at 40-80° C.;
after the separating to obtain the liquid phase, the ammonia water for adjusting a pH of the liquid phase has an ammonia mass concentration of 1-10%, and the ammonia water is added to adjust the pH of the liquid phase to 7.8 to 8.8;
the water-soluable alcohol solution is at least one selected from the group consisting of methanol, ethanol, n-propanol, and i-propanol;
the cooling for precipitation is achieved by cooling to 30° C. to 40° C.;
the nickel complex crystal is at least one selected from the group consisting of Ni(NH₃)₂Cl₂, Ni(NH₃)₃Cl₂, Ni(NH₃)₄Cl₂, Ni(NH₃)₅Cl₂, and Ni(NH₃)₆Cl₂;
wherein in step (3), the light treatment is conducted for 30-90 min with a light wavelength of < 450 nm.

2. The method according to claim 1, wherein in step (1), the dissolving under heating is conducted at 200-350° C. for 30-60 min.

3. The method according to claim 1, wherein before the solid-liquid separation, step (1) further comprises washing the slurry obtained after the dissolving under heating 1-2 times with water of 50-95° C.

4. The method according to claim 1, wherein in steps (1) and (3), the oxidant is one selected from the group consisting of hydrogen peroxide and chlorine.
